(19) United States
(12) Patent Application Publication
(10) Pub. No.: US 2019/0127139 A1
(43) Pub. Date: May 2, 2019

(54) Storage and Protection Assembly for Transport of Cylinders

(71) Applicant: Abdulla Ebraheim Mohamed E. Al Suwaidi, Fujairah (AE)

(72) Inventor: Abdulla Ebraheim Mohamed E. Al Suwaidi, Fujairah (AE)

(21) Appl. No.: 15/728,975

(22) Filed: Oct. 27, 2017

(51) Int. Cl. B65D 81/38; F17C 13/08; B60P 7/135

(52) U.S. Cl. CPC B65D 81/3802; F17C 13/084; F17C 2205/0308; F17C 2201/0109; B60P 7/135

(57) ABSTRACT

The present invention discloses a storage and protection assembly for transporting gas cylinders. The storage and protection assembly of the present invention includes a body with an internal hollow portion for storing a container, and a cap which is adapted to fit within the internal hollow portion of the body. The cap has a primary and a secondary locking mechanism. The primary locking mechanism includes threaded channels on the outer walls of the cap and the secondary mechanism includes spring assisted assemblies which correspond with a plurality of cavities located within the body.

### FIELD OF INVENTION

This invention relates, in general, to containers for holding compressed gas cylinders and, in particular, to a compressed gas cylinder container capable of protecting a compressed gas cylinder from impact.

### BACKGROUND OF INVENTION

Compressed gas cylinders are used in various applications. Typically, compressed gas cylinder comprises a steel cylindrical body having a valve means at the top thereof which may include a pressure gauge. The compressed gas within the cylinder is maintained within the cylinder at high pressures. Therefore, it is often necessary to avoid impact, puncture, or other damage to the cylinder which could create extreme danger or even an explosion. There presently exist, containers for compressed gas cylinders. However, such containers suffer from a variety of shortcomings and may not adequately protect the compressed gas cylinders therein from impact.

In one type of gas cylinder container, four radially directed through-slots are spaced circumferentially around the midsection of a body that can receive a gas cylinder. The user threads a strap through the slots and operates a toggle on the strap to alternatively tighten or release the strap around a gas cylinder inserted into the body. Handles are located on the midsection and end of the body for improved handling. Footings are located on the body exterior in order to prevent rolling of the body about its longitudinal axis. This type of container, however, does not prevent longitudinal movement or shifting of the gas cylinder. The body does not adequately protect the inserted gas cylinder against radial exterior impact or denting. Also, the slots do not adequately seal the gas cylinder against exterior-contaminant exposure.

In another types of container, upper and lower cap-skirts receive the ends of a gas cylinder. A user threads a strap through apertures and grooves on the cap-skirts and runs the strap along sides of a gas cylinder received between the cap-skirts. The user alternatively tightens and releases the strap around the received gas cylinder by operating spring clasps on the strap. A number of radial projections appear on one or more of the cap-skirts in order to prevent rotation of the received gas cylinder about its longitudinal axis. However, the cap-skirts do not protect the received gas cylinder against radial exterior impact or denting.

Thus, a need exists for an impact resistant compressed gas cylinder container that protects the gas cylinder against exterior impact or denting, preferably during transport, and that does not allow for accidental opening of the container during a collision event. A further need exists to provide such protection and to secure the container against longitudinal movement or shifting.

### SUMMARY OF THE INVENTION

The present invention discloses a storage and protection assembly for transporting gas cylinders.

In one embodiment of the present invention, the storage and protection assembly is comprised of:
a body with an internal hollow portion for storing a container, said body having a bottom side and a top side;
a cap which is adapted to fit within the internal hollow portion of the body at said top side;
wherein said cap has a primary and a secondary locking mechanism;
wherein the primary locking mechanism comprises threaded channels on the outer walls of the cap;
wherein the secondary locking mechanism comprises a plurality of spring assisted assemblies which are movable from a unlocked position to a locked position;
wherein the body of the storage assembly has a plurality of cavities circumferentially located in the top side of the internal hollow portion; and
wherein the plurality of spring assemblies are adapted to slide into the plurality of cavities when the secondary locking mechanism is in a locked position.

In one embodiment the container of the present invention is a gas cylinder.

In one embodiment, the body of the assembly can have a circular or square outer shape, however preferably the inner shape of the body conforms to the shape of a gas cylinder, which is typically cylindrical. This is a non-limiting embodiment, as other geometries can also be envisioned, and will be familiar to one of ordinary skill in the art.

The body of the assembly is preferably composed of a sturdy material, including but not limited to a polymeric material, a metal material, reinforced material, a combination of metal and polymer material, and other such known materials which will be apparent to one of ordinary skill in the art.

In one embodiment, the body of the assembly includes an internal bottom portion which comprises a resilient design. This can include an upwardly curved surface of raised bottom portion which will adapt to the shape of a bottom section of a gas cylinder. Additionally, or alternatively, the bottom portion of the body can also include a plurality of springs, which are disposed and movable vertically within the bottom portion, so that the cylinder does not have impact with the bottom portion during movement and transport of the assembly.

The cap of the assembly is adapted to fit in the top portion of the body. In one embodiment, the cap includes a primary and secondary locking mechanism.

The primary locking mechanism can comprise a threaded channels on the outer walls of the cap, which correspond with threaded channels on the internal walls of the body. This locking mechanism is confined to the top portion of the body. Therefore in operation of the primary locking mechanism, a user would simply place the cap within the internal cavity of the body in the top portion, and twist the cap so as to engage the threaded connection between the cap and body. The twisting movement continues under all the threaded channels within the cap and on the internal walls of the body are engaged with each other.

In one embodiment, the cap of the assembly also comprises a secondary locking mechanism, as disclosed above. The secondary locking mechanism is provided so that there can be additional security and impact prevention to the cylinder during storage and transport, while the cylinder is within a vehicle for example, and in any event where the stability of the cylinder may be disturbed, such as for example, bumpy roadways, or in the event of an accident.

In one embodiment the secondary locking mechanism comprises a plurality of spring assisted assemblies which are movable from an unlocked position to a locked position. During engagement of the secondary locking mechanism these spring assisted assemblies are placed in a locking position by engaging with the plurality of cavities circumferentially located in the top side of the internal hollow portion of the body. This is accomplished by the spring assemblies sliding into the plurality of cavities so as to engage the spring assemblies into a locked position, thereby actuating the secondary locking means of the cap and body together.

Similarly, the secondary locking mechanism can be disengaged or placed in an unlocked position by the sliding of the spring assisted assemblies away from and/or outside of the plurality of cavities contained within the top side of the internal hollow portion of the body.

In one embodiment, the spring assisted assemblies are comprised of a rigid metal wire, connected to cylindrical stopper. A spring resides around the rigid metal wire. The spring assemblies are coupled at the opposite end to a central handle of the cap, and it is this central handle that is used to engage or dis-engaged the secondary locking mechanism.

In one embodiment the secondary locking mechanism is placed in a engaged or locked position when the central handle is pushed down by a user. Similarly, the secondary locking mechanism is placed in a dis-engaged or unlocked position when the central handle is pulled upwards by a user, thereby actuating the motion necessary to slide the spring assisted assemblies out of the plurality of cavities which reside within the internal portion walls of the body.

In one embodiment, the spring assisted assemblies are comprised of a metallic material. That is, the rigid wire, the cylindrical stopper and the spring which is around the wire are all comprised of a metallic material. In a preferred embodiment, the metallic material is a resilient and strong metal, such as steel.

The central handle is located, as the name suggest, within a central portion of the cap. Due to its function with engaging and dis-engaged the secondary locking mechanism the central handle is coupled to the wire portion of the spring assisted assemblies. The central handle and the cap itself are preferably comprised of a metallic material. While the central handle is located on the top portion of the cap, the spring assisted assemblies are located within the cap, so that they externally extend outside of the cap circumferentially during engagement, and retract back within slots located within the cap during disengagement.

### BRIEF DESCRIPTION OF THE FIGURES

The accompanying figures are included to provide a further understanding of the invention, and are incorporated in and constitute a part of this specification. The figures illustrate embodiments of the invention and, together with the description, serve to explain the principles of the invention.

In the figures:

FIG. 1 illustrates a side view of an embodiment of the present invention.

FIG. 2 illustrates a cross-sectional view of an embodiment of the present invention.

FIG. 3 illustrates a top view of an embodiment of the present invention.

FIG. 4 illustrates a side view of spring assisted assemblies of the present invention.

### DETAILED DESCRIPTION

In the following Detailed Description, reference is made to the accompanying drawings, which form a part hereof, and in which is shown by way of illustration specific embodiments in which the invention may be practiced. Wherever possible, the same reference numbers are used in the drawings and the description to refer to the same or like parts. Directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention discloses a storage and protection assembly for transporting containers which may contain hazardous materials. In one embodiment the containers can be gas cylinders. Although one of ordinary M the art will understand that the type of container which the protection assembly can be designed for will vary and such modifications are within the scope of this invention.

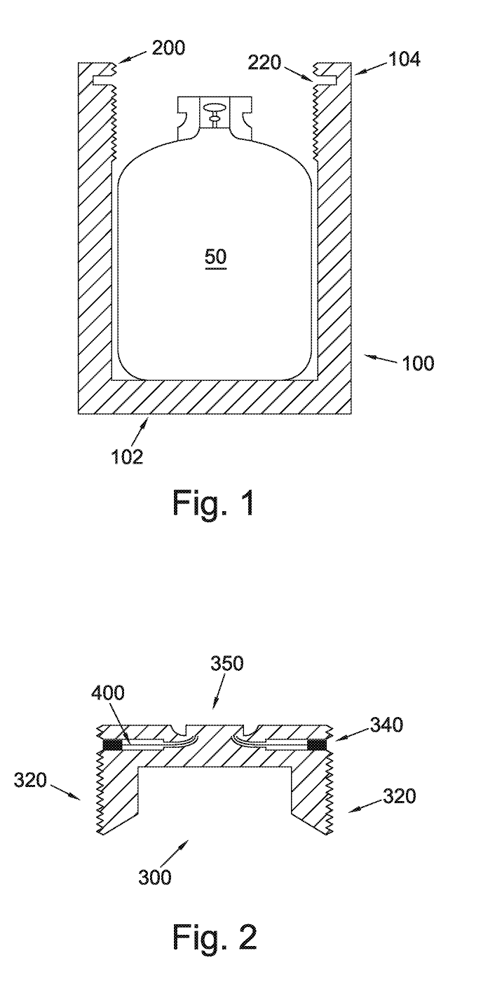

As can be seen in FIGS. 1 and 2, in one embodiment of the present invention, the storage and protection assembly is comprised of:
a body 100 with an internal hollow portion for storing a container 50, said body having a bottom side 102 and a top side 104;
a cap 300 which is adapted to fit within the internal hollow portion of the body 100 at said top side 104;
wherein said cap 300 has a primary 320 and a secondary locking mechanism 340;
wherein the primary locking mechanism comprises threaded channels 320 on the outer walls of the cap;
wherein the secondary locking mechanism 340 comprises a plurality of spring assisted assemblies 400 which are movable from a unlocked position to a locked position;
wherein the body 100 of the storage assembly has a plurality of cavities 220 circumferentially located in the top side of the internal hollow portion; and
wherein the plurality of spring assemblies 400 are adapted to slide into the plurality of cavities 220 when the secondary locking mechanism 340 is in a locked position.

More particularly, FIG. 1 illustrates a cross-sectional view of a body 100 of the storage and protection assembly of the present invention. The body 100 has an internal shape which is capable of accepting and storing a gas cylinder 50 for storage and transport purposes. As can be seen in FIG. 1, the body 100 should be of the size so that a gas cylinder 50 should comfortably fit within the body 100, with some space between the walls of the body 100 and the gas cylinder 50.

The body 100 has a bottom side 102 and a top side 104, which forms the entrance where the gas cylinder can enter through and also where the cap 300 (FIG. 2) can be fitted so as to enclose the gas cylinder 50 within the body 100 for storage and protection. The top side 104 of the body 100 has threaded channels 200 located on the internal walls. These threaded channels 200 correspond and engaged with threaded channels 320 located on the cap 300, and make up the primary locking mechanism of this assembly.

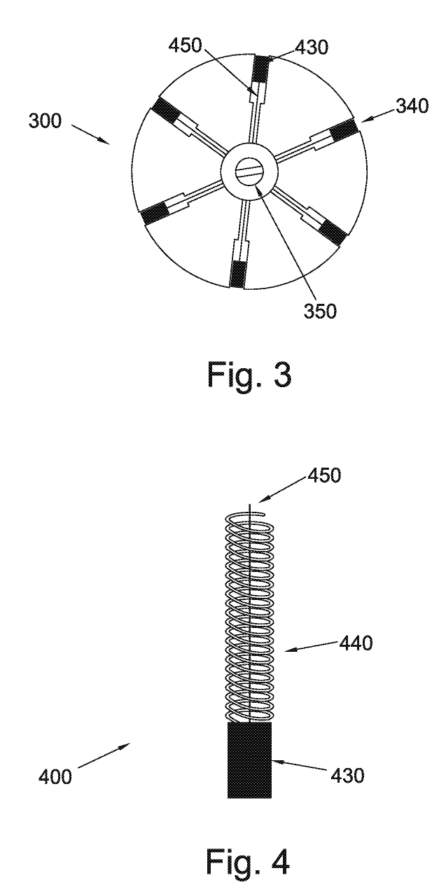

Moving now to FIG. 2, the cap 300 of the assembly is comprised of a shape which aligns with the shape of the body 100, and the cap is designed to fit within the internal top side 104 of the body 100. The sides of the cap are shaped to fit around the cylinder 50 contained in the body 100. The cap 300 contains a primary locking mechanism, and a secondary locking mechanism 340. As described above the primary locking mechanism is comprised of the threaded channels 320 located on the outer walls of the cap 300. The secondary locking mechanism 340 is comprised of spring assisted assemblies 400 which can be seen in FIGS. 3 and 4 and will be described in more detail below.

As can be seen in FIG. 2, the cap 300 had a central handle 350. A top view of this is also shown in FIG. 3. The central handle is responsible for actuating the secondary locking mechanism 340, either in a locked or unlocked position. The cap 300 has a plurality of internal channels, as can be seen in both FIGS. 2 and 3. The internal channels are where the spring assisted assemblies 400 reside (for purposes of simplicity the spring component is not shown in FIGS. 2 and 3, hut can be seen in detail in FIG. 4). As can be seen the internal channels are disposed throughout the cap, each channel having a spring assisted assembly 400 residing therein. The internal channels run have an opening on the sides of the cap 300, so that the spring assisted assemblies 400 can slide out of the cap 300 when it is time to engage the secondary locking mechanism 340.

In one embodiment the central handle 350 is configured to be pressed down towards the body 100 to engage the secondary locking mechanism 340 to a locked position, and to be pulled upwards away from the body to disengage the secondary locking mechanism to an unlocked position. Disengaging the secondary locking mechanism 340 through upward movement of the central handle causes the spring assisted assemblies 400 to retract away from the plurality of cavities 220 contained in the body 100 and rest within internal channels disposed throughout the cap 300.

Moving now to FIG. 3, a top cross-sectional view of the cap 300 is shown. As can be seen in this embodiment the cap contains about 6 spring assisted assemblies 400 disposed equidistantly throughout the cap 300. The internal channels where the spring assisted assemblies 400 reside have a narrowed portion and an enlarged portion. The internal channels can have any cross-sectional shape desired, for example, cylindrical, square or rectangular, although a preferred shape is cylindrical. This also corresponds to the shape of the stopper 430, and the cavities 220. All three of these components preferably have the same cross-sectional shape as for purposes of ease of fit in and out while the secondary locking mechanism 340 is engaged and disengaged during operation.

As can be seen in FIG. 3, the narrowed portion of the internal channels due to its geometry and narrowed cross-section, confines the spring assisted assemblies 400 within the internal channels. Once the central handle 350 is pulled upwards to disengaged the spring assisted assemblies 400 and retract the stopper 430 from the cavities 220 and back into the internal channel, the narrowed portion of the internal channels acts as a stopping point for the spring assisted assemblies so that the stopper 430 cannot be pulled out of the internal channels as the central handle 350 is being pulled upwards.

As can be seen in FIGS. 3 and 4, in one embodiment the spring assisted assemblies 400 are comprised of a metal wire 450, a stopper 430 and a spring 440 (only shown in FIG. 4). The metal wire 450 is coupled to the stopper 430, and the spring 440 resides around the metal wire 450. The metal wire 450 is also coupled to a central handle 350 of the cap 300, on the opposite side from the stopper 430 side.

The stopper 430 can have a cylindrical, square or rectangular shape, although preferably a cylindrical shape. Each component of the spring assisted assemblies 400, including the wire 450, the stopper 430 and the spring 440 are preferably comprised substantially of a metal material, although other materials having sufficient strength and resilience can be envisioned and will be known to those skilled in the art. The central handle 350 is also preferably comprised of the same material of the spring assisted assembly as it is connected to the assemblies 400 and requires resiliency and sturdiness. A metal material is preferred for this purpose, for example steel.

During operation of the secondary locking mechanism 340, for purposes of engaging the locking mechanism 340, the spring assisted assemblies 400 are placed in a locking position by engaging with the plurality of cavities 220 circumferentially located in the top side 104 of the internal hollow portion of the body 100. This is accomplished by stoppers 430 sliding into the plurality of cavities 220 so as to engage the spring assisted assemblies 400 into a locked position, thereby actuating the secondary locking means of the cap 300 and body 100 together. Therefore in a locked position the central handle 350 is pressed down, and this motion pushes the metal wire 450 outwardly from the cap, and also pushes the stopper 430 attached to the wire 450 outwardly towards and into the cavities 220 contained on the internal walls of the body. As can be understood, for this locking motion to work, the plurality of cavities 220 and the spring assisted assemblies should be the same number. For example in the Embodiment shown in FIG. 3 there are six spring assisted assemblies 400 depicted. This would necessitate that in the body 100 shown in FIG. 1, there would also need to be six cavities 220 corresponding with the number of spring assisted assemblies 400.

If a user wishes to unlock or disengage the secondary locking mechanism 340, then the user would have to pull upwards on the central handle 350, and this retracts the stoppers 430 from cavities 220 and back into the internal channels contained within the cap. The narrowed portion of the internal channels as can be seen in FIG. 3, acts as a barrier and does not allow the stopper to be pulled further up within the internal channel. The spring 440 also assists in this. It is because of spring 440 that the central handle 350 will not spontaneously disengage during for example a collision or of the body 100 gets damaged in any way. The stopper 430 should be of a size so that it can comfortably fit within the internal channels and the cavities 220, therefore its cross-sectional size should be less than that of the internal channels and cavities 200, and enough so as to avoid friction between the walls during engaging and disengaging of the secondary locking mechanism 340.

The combination of the primary locking mechanism containing the threaded channels 320 on the cap and threaded channels 200 on the body, in addition to the secondary locking mechanism 340 provide a dual locking means for the assembly of the present invention, which protects the contents within and does not allow for the contents to be accidentally dislodged from the container, thus protecting them during transport. This is particularly important in terms of dangerous materials such as those typically contained in gas cylinders.

The body 100 of the assembly is preferably composed of a sturdy material, including but not limited to a polymeric material, a metal material, reinforced material, a combination of metal and polymer material, and other such known materials which will be apparent to one of ordinary skill in the art.

In one embodiment, the body 100 of the assembly includes an internal bottom portion which comprises a resilient design. This can include an upwardly curved surface or raised bottom portion (not shown) which will adapt to the shape of a bottom section of a gas cylinder 50. Additionally, or alternatively, the bottom portion of the body 100 can also include a plurality of springs (not shown), which placed throughout the bottom section and are disposed and movable vertically within the bottom portion, so that the cylinder does not have impact with the bottom portion during movement and transport of the assembly, but rather is cushioned instead by the motion of the springs underneath it.

In a further embodiment, the body 100 of the present invention can also further comprise a layer of a reinforcing material on the internal walls, either within the walls and/or on the surface of the walls. This reinforcing material can be dispersed throughout the body in a lattice configuration, a matrix, a repeating or a randomized pattern configuration. The reinforcing material placed throughout the body's internal walls can be selected from a polymer, a polymer composite, a metal, a metal wire, a reinforced fiber, inorganic fibers, and a metal polymer composite.

While particular embodiments of present invention have been shown and described, it is apparent that changes and modifications may be made therein without departing from the invention in its broadest aspects. Various combinations of these embodiments can be made. The aim of the appended claims, therefore, is to cover all such changes and modifications as fall within the true spirit and scope of the invention.

1. A storage and protection assembly for transporting containers comprising:
a body with an internal hollow portion for storing a container, said body having a bottom side and a top side;
a cap which is adapted to fit within the internal hollow portion of the body at said top side;
wherein said cap has a primary and a secondary locking mechanism;
wherein the primary locking mechanism comprises threaded channels on the outer walls of the cap;
wherein the secondary locking mechanism comprises a plurality of spring assisted assemblies which are movable from an unlocked position to a locked position;
wherein the body of the storage assembly has a plurality of cavities circumferentially located in the top side of the internal hollow portion; and
wherein the plurality of spring assemblies are adapted to slide into the plurality of cavities when the secondary locking mechanism is moved from an unlocked to a locked position.

2. The storage and protection assembly of claim 1, wherein the container is a gas cylinder.

3. The storage and protection assembly of claim 1, wherein the plurality of spring assisted assemblies reside within internal channels disposed throughout the cap.

4. The storage and protection assembly of claim 1, wherein the plurality of spring assisted assemblies are comprised of the following;
a metal wire;
a stopper; and
a spring;
wherein, the metal wire is coupled to the stopper, and wherein the spring resides around the metal wire.

5. The storage and protection assembly of claim 4, wherein the metal wire of the plurality of spring assisted assemblies is coupled to a central handle of the cap.

6. The storage and protection assembly of claim 4, wherein the stopper has a cylindrical, square or rectangular shape.

7. The storage and protection assembly of claim 1, wherein the plurality of the spring assisted assemblies are comprised substantially of a metal material.

8. The storage and protection assembly of claim 5, wherein the central handle is configured to be pressed down towards the body to engage the secondary locking mechanism to a locked position, and to be pulled upwards away from the body to disengage the secondary locking mechanism to an unlocked position.

9. The storage and protection assembly of claim 8, wherein the plurality of wherein disengaging the secondary locking mechanism through upward movement of the central handle causes the spring assisted assemblies to retract away from the plurality of cavities and rest within internal channels disposed throughout the cap.

10. The storage and protection assembly of claim 1, wherein the body has an internal bottom portion that provides cushioning for the gas cylinder.

11. The storage and protection assembly of claim 9, wherein the cushioning at the internal bottom portion is provided by a plurality of vertical springs disposed throughout the internal bottom portion of the body.

12. The storage and protection assembly of claim 1, wherein the internal bottom portion of the body has an upwardly curved surface, which conforms to a curved bottom surface of a gas cylinder.

13. The storage and protection assembly of claim 4, wherein the internal channels disposed throughout the cap have a narrowed portion and an enlarged portion.

14. The storage and protection assembly of claim 12, wherein the enlarged portion of the internal channels has a cylindrical, square or rectangular shape.

15. The storage and protection assembly of claim 1, wherein the plurality of cavities have a cylindrical, square or rectangular shape.

16. The storage and protection assembly of claim 3, wherein the narrowed portion confines the spring assisted assemblies within the internal channels.

17. The storage and protection assembly of claim 1, wherein the body further comprises a layer of a reinforcing material on the internal walls, either within the walls and/or on the surface of the walls.

18. The storage and protection assembly of claim 12, wherein the reinforcing material is uniformly disposed throughout the body's internal walls, and is comprised of a material selected from a polymer, a polymer composite, a metal, a reinforced fiber, and a metal polymer composite.
